(19) United States
(12) Patent Application Publication
(10) Pub. No.: US 2014/0293135 A1
(43) Pub. Date: Oct. 2, 2014

(54) POWER SAVE FOR AUDIO/VIDEO TRANSMISSIONS OVER WIRED INTERFACE

(71) Applicant: SAMSUNG ELECTRONICS CO., LTD., Suwon-si (KR)

(72) Inventors: Huai-Rong Shao, San Jose, CA (US); Kyeong-Jae Lee, Seoul (KR); Chiu Ngo, Millbrae, CA (US); Jonghwa Kim, Suwon-si (KR); Ilju Na, Seongnam City (KR)

(73) Assignee: SAMSUNG ELECTRONICS CO., LTD., Suwon-si (KR)

(21) Appl. No.: 14/231,540

(22) Filed: Mar. 31, 2014

Related U.S. Application Data
(60) Provisional application No. 61/807,544, filed on Apr. 2, 2013.

(51) Int. Cl. H04N 5/63; H04N 5/14

(52) U.S. Cl. CPC H04N 5/63; H04N 5/14
USPC 348/634; 348/725

(57) ABSTRACT

A method and system for providing power saving for wired connected devices. The method includes determining a power saving mode by one or more of a first communication device and a second communication device based on one or more of a video content state and one or more un-allocated communication paths. A power saving operation is performed while using a wired link between the first communication device and the second communication device based on the determined power saving mode.

### CROSS-REFERENCE TO RELATED APPLICATIONS

This application claims the priority benefit of U.S. Provisional Patent Application Ser. No. 61/807,544, filed Apr. 2, 2013, incorporated herein by reference in its entirety.

### TECHNICAL FIELD

One or more embodiments generally relate to providing power saving for wire connected devices, in particular, to providing a power save operation based on content state and communication path allocation.

### BACKGROUND

Many individuals play content, such as video and audio content, from mobile devices to other devices, such as television devices, monitors, computers, etc. Different types of wire connectors or cables may be used to connect the devices for communication. Some wired devices may be powered or charged from the wire connection between devices.

### SUMMARY

One or more embodiments generally relate to providing power saving for electronic devices connected with a wired connection device. In one embodiment, the method includes determining a power saving mode by one or more of a first communication device and a second communication device based on one or more of a video content state and one or more un-allocated communication paths. In one embodiment, a power saving operation is performed while using a wired link between the first communication device and the second communication device based on the determined power saving mode.

In one embodiment, a system is provided that includes a wire connection device. In one embodiment, a first communication device is coupled to a first connector of the wire connection device, and a second communication device is coupled to a second connector of the wire connection device. In one embodiment, one or more of the first communication device and the second communication device determines a power saving mode based on one or more of a video content state and one or more un-allocated communication paths for the wire connector, and performs a power saving operation based on the determined power saving mode.

In one embodiment a non-transitory computer-readable medium having instructions which when executed on a computer perform a method comprising: determining a power saving mode by one or more of a first communication device and a second communication device based on one or more of a video content state and one or more un-allocated communication paths. In one embodiment, a power saving operation is performed while using a wired link between the first communication device and the second communication device based on the determined power saving mode.

These and other aspects and advantages of one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of architecture for a system including wire connected electronic devices, according to an embodiment.

FIG. 3 shows an example system including wire link connected source device and sink device, according to an embodiment.

FIG. 4 shows an example transmitter pipeline, according to an embodiment.

FIG. 5 shows an example packet header format including an IDLE control packet type, according to an embodiment.

FIG. 6 shows an example ECBUS time division multiplex (TDM) approach used by an embodiment.

FIG. 7 shows example extended device status registers used by an embodiment, according to an embodiment.

FIG. 8 shows an example of extended device registers with AV Lane count and AVLANE TDM allocation use registers, according to an embodiment.

FIG. 9 shows a process for providing power saving for wire connected devices, according to one embodiment.

FIG. 10 is a high-level block diagram showing an information processing system comprising a computing system implementing one or more embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Embodiments relate to providing power saving for electronic devices connected with a wired connection device. In one embodiment, a method includes determining a power saving mode by one or more of a first communication device and a second communication device based on one or more of a video content state and one or more un-allocated communication paths. In one embodiment, a power saving operation is performed while using a wired link between the first communication device and the second communication device based on the determined power saving mode.

One or more embodiments provide power saving for wire connected devices (e.g., via a mobile high-definition link (MHL) connection, a high-definition multimedia interface (HDMI) connection, etc.) for audio only and content mute modes. In one embodiment, a transmitter skips the packetization of the blank video values in the active period and adds gap characters automatically when no data from, for example, a packet formatter; and a receiver regenerates the blank video values in active video periods for content mute mode and ignores active video periods for audio only mode. In one embodiment, a new transition minimized differential signaling (TMDS) packet type referred to as IDLE Control is provided. In one embodiment, the payload uses the IDLE Control packet type to indicate in how many link clock ticks the transmitter will be idle (i.e., no data to be transmitted) after the IDLE control packet. In one embodiment, for an MHL connection, audio data and control information is transmitted in the T-CBUS (tunneling CBUS) on the eCBUS link and places AV physical channels (lanes) in a standby or shutdown state.

In one embodiment, power saving for the eCBUS for an MHL connection is provided using the IDLE Control packet sent in the T-CBUS to indicate how long the transmitter and receiver may remain at an IDLE state instead of sending IDLE characters (as with conventional MLH connected devices). In one embodiment, for un-allocated sub-channels (Null time slots), which are not used by the CBUS1, eMSC or T-CBUS, both the transmitter and receiver remain at a standby state.

In one embodiment, power saving is provided for a deep-sleep operation. In one embodiment, if no content needs to be transmitted through a wire connection interface (e.g., MHL), the transmitter and receiver may proceed to a deep sleep state in which all AV physical channels (lanes) and also the eCBUS are placed in a standby or a shutdown state. In one embodiment, only a Bootstrap CBUS (bCBUS) remains awake and waits for the sleep time out or interruptions triggered externally, such as via a user command. In one embodiment, before the transmitter and receiver enter a deep sleep, both the transmitter and the receiver record all the configuration status of AV channels and the eCBUS (e.g., in status registers). In one embodiment, when the transmitter and receiver need to wake up from the deep-sleep state, both the transmitter and the receiver resume the configurations of the AV channels (lanes) and eCBUS immediately without going through the regular initiation process based on retrieving the stored/saved configuration status.

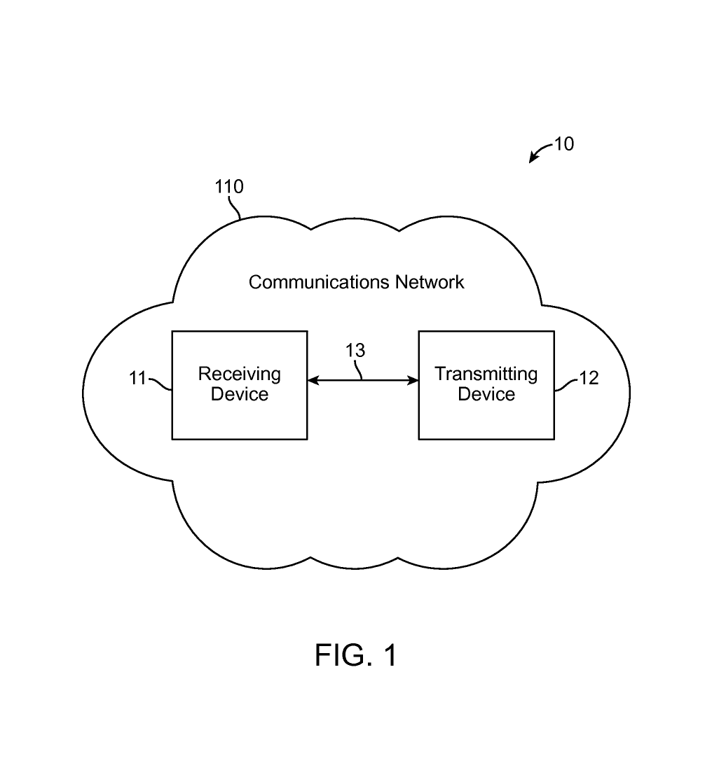

FIG. 1 is a schematic view of a communications system 10, in accordance with one embodiment. Communications system 10 may include a communications device that initiates an outgoing communications operation (transmitting device 12) and a communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include multiple transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., an IEEE 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, the communications network 110 may support protocols used by wireless and cellular phones and personal email devices (e.g., a Blackberry®). Such protocols may include, for example, GSM, GSM plus EDGE, CDMA, quadband, and other cellular protocols. In another example, a long range communications protocol can include Wi-Fi and protocols for placing or receiving calls using VOIP, LAN, WAN, or other TCP-IP based communication protocols. The transmitting device 12 and receiving device 11, when located within communications network 110, may communicate over a bidirectional communication path such as path 13, or over two unidirectional communication paths. Both the transmitting device 12 and receiving device 11 may be capable of initiating a communications operation and receiving an initiated communications operation.

The transmitting device 12 and receiving device 11 may include any suitable device for sending and receiving communications operations. For example, the transmitting device 12 and receiving device 11 may include mobile telephone devices, television (TV) systems (e.g., high-definition (HD) TVs (HDTVs), ultra-high definition TVs (UDTVs), monitors, displays, cameras, camcorders, a device with audio video capabilities, tablets, wearable devices, and any other device capable of communicating wirelessly (with or without the aid of a wireless-enabling accessory system) or via wired pathways (e.g., MHL, HDMI, using traditional telephone wires, etc.). The communications operations may include any suitable form of communications, including for example, voice communications (e.g., telephone calls), data communications (e.g., e-mails, text messages, media messages), video communication, audio communication, audio-video (AV) communication, or combinations of these (e.g., video conferences).

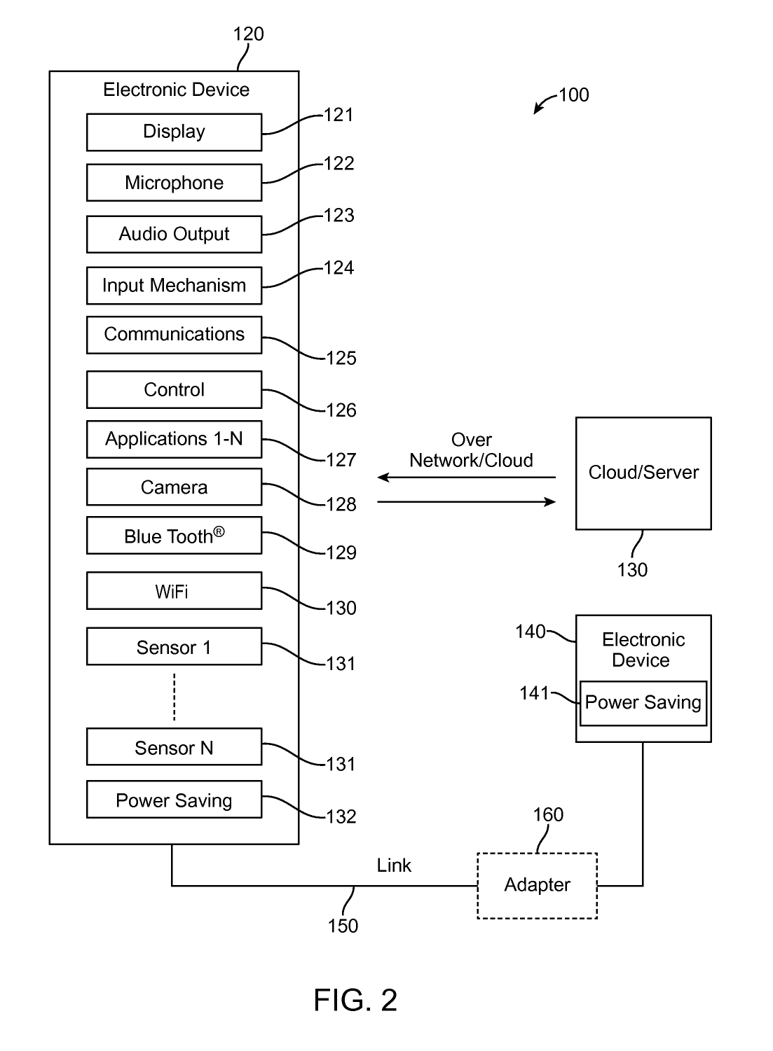

FIG. 2 shows a functional block diagram of an architecture system 100 that may be used for providing power saving for electronic devices 120 and 140. Both the transmitting device 12 and receiving device 11 may include some or all of the features of the electronics device 120 or 140. In one embodiment, the electronic device 120 may comprise a display 121, a microphone 122, an audio output 123, an input mechanism 124, communications circuitry 125, control circuitry 126, Applications 1-N 127, a camera module 128, a BlueTooth® module 129, a Wi-Fi module 130, sensors 1 to N 131 (N being a positive integer), a power saving module 132 and any other suitable components. In one embodiment, applications 1-N 127 are provided and may be obtained from a cloud or server 130, a communications network 110, etc., where N is a positive integer equal to or greater than 1. In one embodiment, the system 100 includes a wired link 150 (e.g., MHL, HDMI, etc.) that connects the electronic device 120 with the electronic device 140. In one embodiment, the electronic device 120 may comprise a mobile device (e.g., smart phone, camera, content player, video recorder, tablet, wearable device, etc.) and electronic device 140 may comprise a TV device (e.g., HDTV device, UDTV device, etc.), a monitor, display, etc. In one embodiment, an optional adapter 160 may comprise a MHL to HDMI adapter, an HDMI to MHL adapter, etc. In one embodiment, the electronic device 140 may include a power saving module 141 for saving power by the processes and systems of one or more embodiments. In one embodiment, the electronic device may act as a transmitter of content (e.g., AV content, audio only content, video only content, etc.) through the link 150 to the electronic device 140, which may act as a receiver of the content.

In one embodiment, all of the applications employed by the audio output 123, the display 121, input mechanism 124, communications circuitry 125, and the microphone 122 may be interconnected and managed by control circuitry 126. In one example, a handheld music player capable of transmitting music to other tuning devices may be incorporated into the electronics device 120.

In one embodiment, the audio output 123 may include any suitable audio component for providing audio to the user of electronics device 120. For example, audio output 123 may include one or more speakers (e.g., mono or stereo speakers) built into the electronics device 120. In some embodiments, the audio output 123 may include an audio component that is remotely coupled to the electronics device 120. For example, the audio output 123 may include a headset, headphones, or earbuds that may be coupled to communications device with a wire (e.g., coupled to electronics device 120 with a jack) or wirelessly (e.g., Bluetooth® headphones or a Bluetooth® headset).

In one embodiment, the display 121 may include any suitable screen or projection system for providing a display visible to the user. For example, display 121 may include a screen (e.g., an LCD screen) that is incorporated in the electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app), social networking applications (e.g., Facebook®, Twitter®, Etc.), an Internet browsing application, etc. In some embodiments, the electronics device 120 may include one or multiple applications operative to perform communications operations. For example, the electronics device 120 may include a messaging application, a mail application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include microphone 122 to allow the user to transmit audio (e.g., voice audio) for speech control and navigation of applications 1-N 127, during a communications operation or as a means of establishing a communications operation or as an alternative to using a physical user interface. The microphone 122 may be incorporated in the electronics device 120, or may be remotely coupled to the electronics device 120. For example, the microphone 122 may be incorporated in wired headphones, the microphone 122 may be incorporated in a wireless headset, the microphone 122 may be incorporated in a remote control device, etc.

In one embodiment, the camera module 128 comprises one or more camera devices that include functionality for capturing still and video images, editing functionality, communication interoperability for sending, sharing, etc. photos/videos, etc.

In one embodiment, the BlueTooth® module 129 comprises processes and/or programs for processing BlueTooth® information, and may include a receiver, transmitter, transceiver, etc.

In one embodiment, the electronics device 120 may include multiple sensors 1 to N 131, such as accelerometer, gyroscope, microphone, temperature, light, barometer, magnetometer, compass, radio frequency (RF) identification sensor, etc.

In one embodiment, the electronics device 120 may include any other component suitable for performing a communications operation. For example, the electronics device 120 may include a power supply, ports, or interfaces/connectors/ports for coupling to a host device, a secondary input mechanism (e.g., an ON/OFF switch), or any other suitable component.

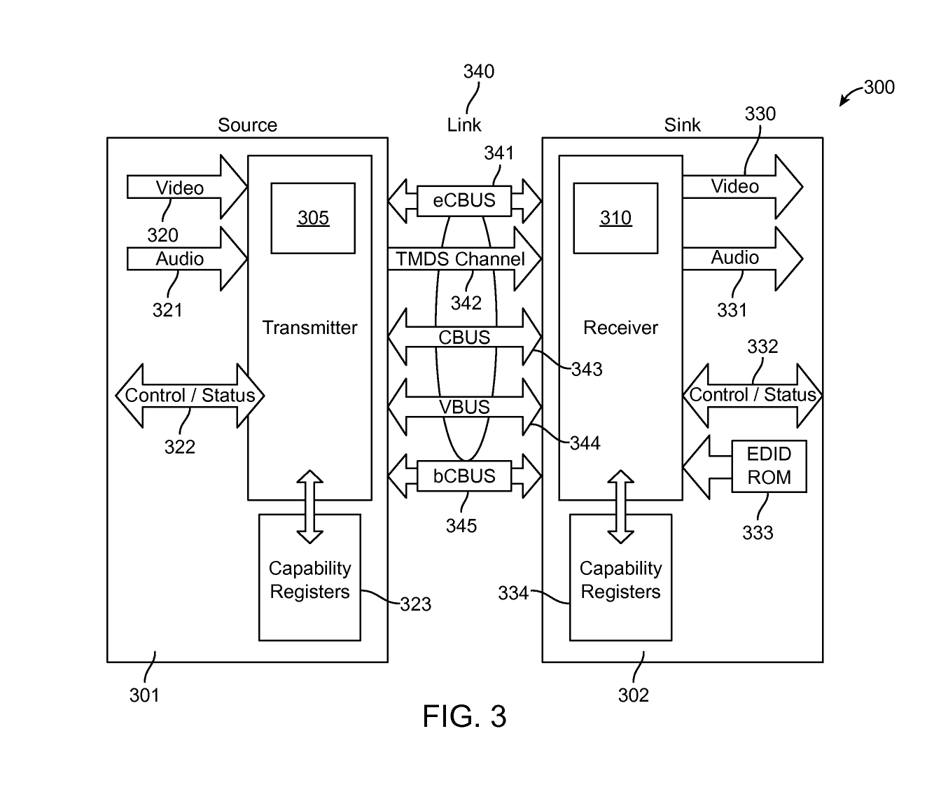

FIG. 3 shows an example system including wire link 340 connected source device 301 and sink device 302, according to an embodiment. In one embodiment, the wire link 340 comprises an MHL wire link. It should be noted, however, that one or more embodiments may be implemented with HDMI wire links, etc. In one embodiment, the transmitter device 305 may receive video content 320, audio content 321 and communicate (e.g., receive/transmit) control/status information 322 from a content source (e.g., memory, streaming, an electronic device 120 (FIG. 2), etc.). In one embodiment, the receiver device 310 communicates video content 330, audio content 331 and communicates (e.g., receive/transmit) control/status information 332 from a content sink (e.g., memory, display, an electronic device 140 (FIG. 2), etc.). In one embodiment, the receiver receives extended display identification data (EDID) from EDID ROM 333 (e.g., from an electronic device 140 display, monitor, etc.).

In one embodiment, the transmitter device 305 retrieves/stores (e.g., reads/writes) data (e.g., status information, configuration information, etc.) to from/to the capability registers 323. In one embodiment, the receiver device 310 retrieves/stores (e.g., reads/writes) data (e.g., status information, configuration information, etc.) to from/to the capability registers 334.

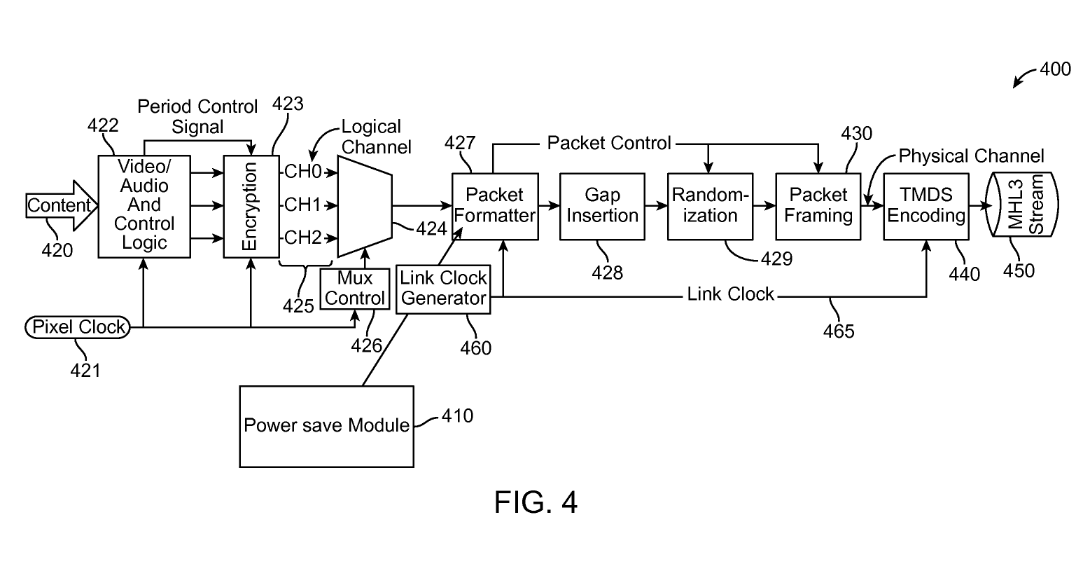

In one embodiment, when the link 340 is an MHL interface/connection, the link 340 includes the physical and logical paths (e.g., lanes, channels, sub-channels) such as the eCBUS 341, TMDS channel(s) 342, CBUS 343, VBUS 344, bCBUS 345, etc. In one embodiment, the transmitter device 305 of the source 301 communicates over the wired link 340 with the receiver device 310 of the sink 302 for communicating content (e.g., AV content, etc.). In one embodiment, the transmitter includes a power save module (e.g., power save module 410 (FIG. 4)) for controlling and providing power saving using the wire link 340 in connection with the receiver device 310 as discussed below.

FIG. 4 shows an example transmitter pipeline 400, according to an embodiment. In one embodiment, the pipeline 400 is implemented for an MHL link (e.g., MHL link 340, FIG. 3). In one embodiment, the transmitter pipeline includes communicated content 420 (e.g., AV content, etc.) and pixel clock data 421 from a content source (e.g., storage, streaming AV content from a network/Internet, electronic device 120, etc.). In one embodiment, the content 420 is provided to the video/audio and control logic module 422. In one embodiment, the period control signal from the video/audio and control logic module 422 is provided to the encryption module 423 that encrypts data over logical channels 425.

In one embodiment, the data from the logical channels 425 are combined with multiplexor 424 using multiplex control module 426. In one embodiment, the output from the multiplexor 424 is communicated over a physical path to the packet formatter 427 that includes a power save module 410 for providing power saving processing between the transmitter (e.g., transmitter device 305 (FIG. 3) and the receiver device 310 over the link 340). In one embodiment, the packet formatter uses data from the link clock generator 460 for formatting packets and for packet control. The output of the packet formatter is provided to the gap insertion module 428 along with packet control information that is provided to the packet framing module 430. In one embodiment, the output from the gap insertion module is provided to the randomization module 429, whose output is provided to the packet framing module 430. In one embodiment, the output from the packet framing module 430 is provided to the TMDS encoding module 440 along with data from the link clock 465. In one embodiment, the output from the TMDS module 440 is provided as an MHL stream 450 for use of an electronic device 140 (FIG. 2).

It should be noted that although conventional MHL connections support power charging functionality from the receiver to the transmitter, one or more embodiments provide for reduced power consumption. In a conventional MHL connection (e.g., MHL Specification Version 3.0) between a transmitter and receiver, the blanking periods (including control and data islands) and active video periods are always packetized into data packets at the physical channel even though no real data information is specified. For example, for audio only transmission, no real video data is included within an active video period, but the blank video values in active periods are still packetized and transmitted via the physical channel. For another example, in a content mute mode, the blank video values instead of the real video pixel values in the active periods are packetized and transmitted via the physical channel.

In one embodiment, the power save module 410 of the transmitter (e.g., transmitter device 305, FIG. 3) skips the packetization of the blank video values in the active video period, and adds the gap characters automatically when no content data is required from the packet formatter module 427; and the receiver (e.g., receiver device 310, FIG. 3) regenerates the blank video values in the active video periods for a content mute mode, and ignores active video periods for an audio content only mode. In one embodiment, the standard packet formatter is modified with the power save module 410 that provides the skipping of packetization of the blank video values in the active video period. In one embodiment, the skipping of packetization of the blank video values provides power saving by reducing transmission over the physical link from the transmitter device 305 (FIG. 3) to the receiver device 310.

In one embodiment, the power save module 410 determines that the power save mode is based on the content state, which is determined to be based on the transmitter having no content data that is required to be forwarded by the packet formatter (e.g., no video data, audio only, content mute mode, etc.), which triggers (or intercepts) typical instructions to packet blank video values for the active video period. In one embodiment, the power save module 410 prohibits forwarding packets and reduces transmission of blank video content.

In one embodiment, if the power save mode is determined based on no video content in an audio only mode, the transmitter device 305 transmits audio data and control information in the T-CBUS (tunneling CBUS) on the eCBUS link and places the AV physical channel (lane) in a standby or shutdown state for saving power.

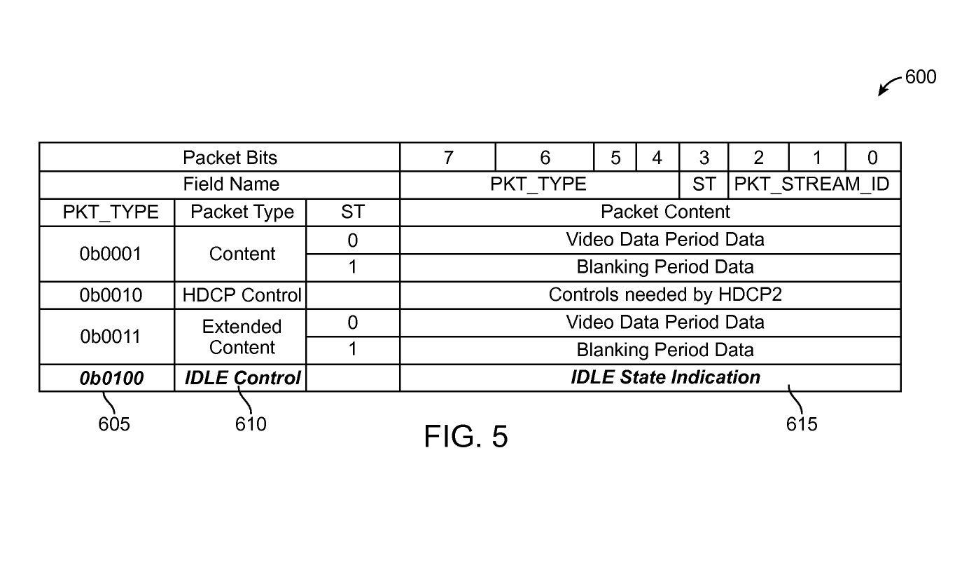

FIG. 5 shows an example packet header format 600 including an IDLE control packet 615 type, according to an embodiment. In one embodiment, the TMDS packet type, IDLE Control 615, is provided by the power saving module 410 as shown in bold and italic font for packet header format 600. In one embodiment, the IDLE Control packet 615 may comprise a small payload (e.g., 2 bytes, etc.) that indicates in how many link clock 465 ticks the transmitter device 305 (FIG. 3) will be idle (e.g., no data to be transmitted) after the IDLE Control packet 615. In one embodiment, the Idle Control packet 615 may be represented with a code/address 605 and has the name “IDLE Control” 610. In one embodiment, the power save module 410 generates an IDLE Control packet 615 that is used for power save modes/states as described herein.

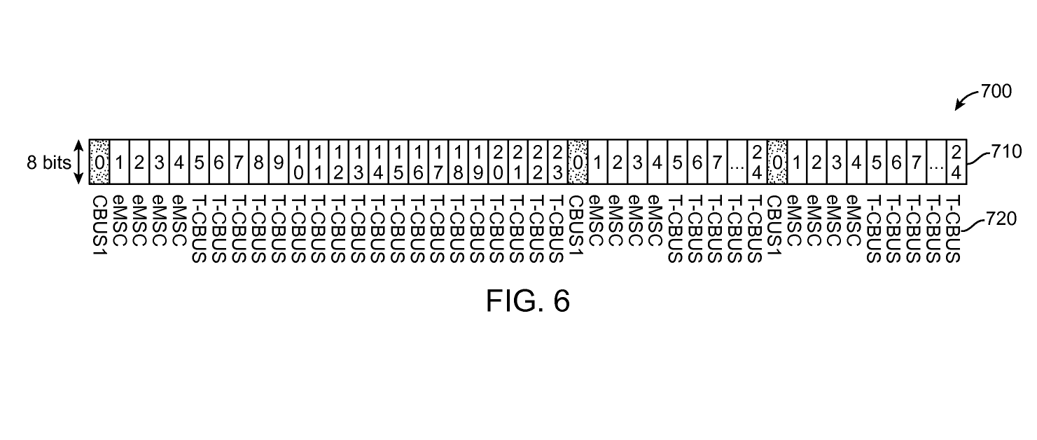

FIG. 6 shows an example ECBUS time division multiplex (TDM) approach 700 used by an embodiment. In one embodiment, for the eCBUS in MHL connections, a TDM approach is for channel time allocation. The eCBUS channel time is divided by a fixed number of sub-channels (time slots) 710 periodically for different sub-channels 720 as shown in the example 700. In the current MHL specification, when there is no data to be sent, the T-CBUS sends IDLE characters. In one embodiment, to reduce power consumption, an IDLE Control packet 615 is sent in the T-CBUS to indicate how long the transmitter device 305 (FIG. 3) and receiver device 310 can remain in an IDLE state, instead of sending IDLE characters (as with conventional MHL connected devices) when the power save module 410 determines the power save mode is based on no content data (e.g., no video content, audio only, mute mode, etc.). In one embodiment, by maintaining the transmitter device 305 and receiver device 310 in an IDLE state, less power is consumed in operating the transmitter device 305 and receiver device 310.

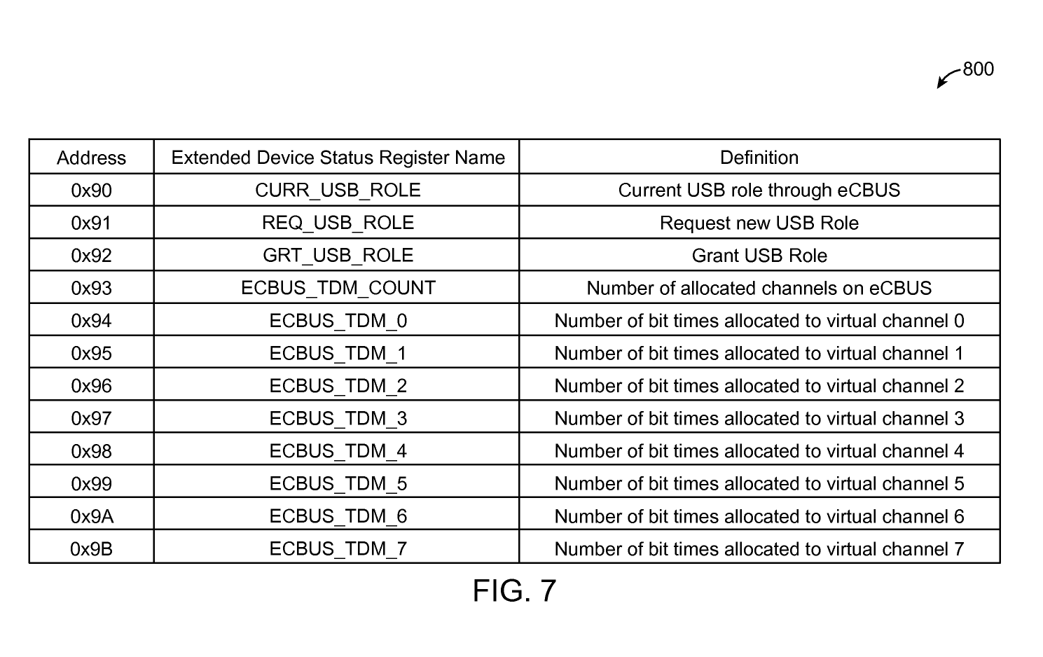

FIG. 7 shows example 800 of extended device status registers used by an embodiment. In one embodiment, for un-allocated sub-channels (e.g., null time slots), which are not used by the CBUS1, eMSC or T-CBUS, both the transmitter device 305 (FIG. 3) and the receiver device remain in a standby state based on processing by the power save module 410 (FIG. 4), or other power save modules employed in the transmitter device 305 and receiver device 310.

In one embodiment, the transmitter device 305 and the receiver device 310 determine to remain in a standby state based on reading the ECBUS_TDM_COUNT register in the Extended Device Status Registers 800. In one embodiment, un-allocated channels may be determined by subtracting the ECBUS_TDM_COUNT from the total number of eCBUS channels, which indicates the number of un-allocated channels. In one embodiment, the transmitter and/or receiver may determine the power save mode is based on un-allocated sub-channels based on the determination that no communication is required on the un-allocated sub-channels, where the transmitter device 305 and receiver device 310 may remain in standby. The transmitter device 305 and the receiver device 310 may determine which sub-channels are un-allocated by reading the Extended Device Status Registers 800.

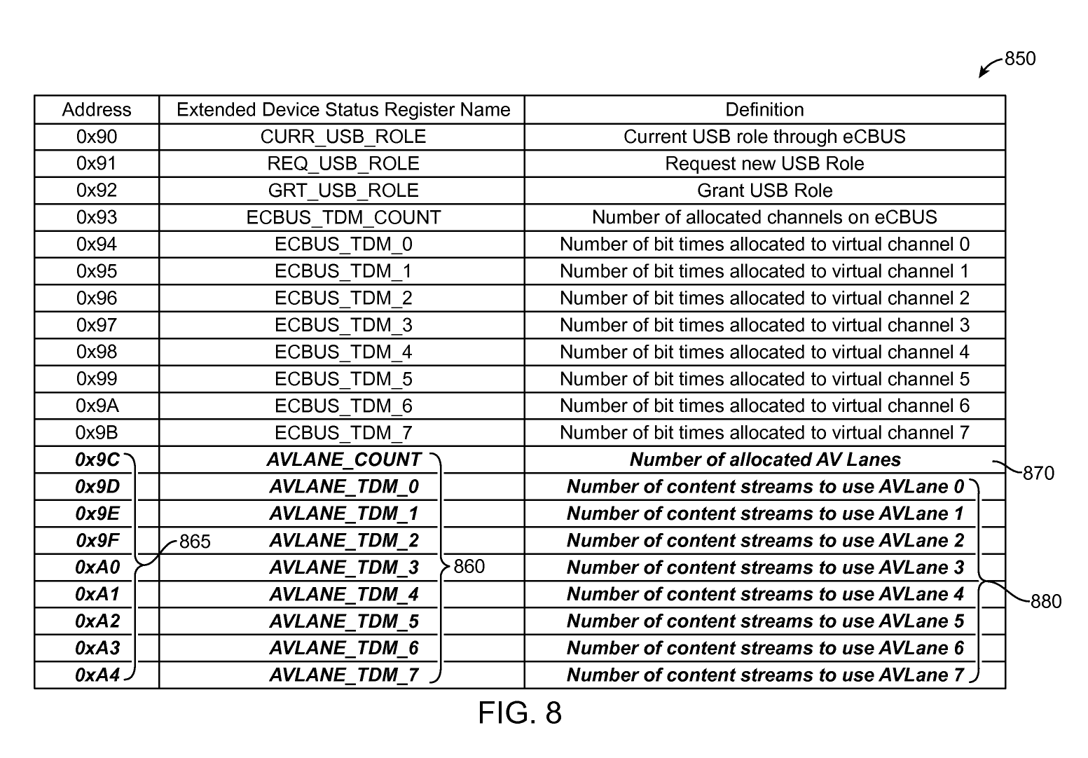

FIG. 8 shows an example 850 of extended device registers with AV Lane count and AVLANE TDM 860 allocation use registers, according to an embodiment. In one embodiment, the AVLANE COUNT 870 is defined as the number of allocated AV lanes, and the AVLANE_TDM#9 e.g., 0-7) 860 is defined as the number of content streams to use for the specific AVLane# (e.g., 0-7) 880. For an MHL connection between the transmitter device 305 (FIG. 3) and receiver device 310, MHL will support multiple AV physical channels (lanes) to further increase the data rate. In one embodiment, the transmitter device 305 and the receiver device 310 use the power save module 410 (or other power save module in the transmitter and/or receiver device 310) to place one or more unused AV physical channels (lanes) in a standby or a shutdown state in order to reduce power consumption. In one embodiment, power save mode is based on an un-allocated channel determination. In one embodiment, the transmitter device 305 and the receiver device 310 determine that un-allocated channels exist by reading the AVLANE_COUNT 870 value in the enhanced Extended Device Status Registers 850. In one embodiment, the number of un-allocated channels is determined by subtracting AVLANE_COUNT 870 from the total number of AV physical channels (lanes).

In one embodiment, if no content needs to be transmitted through the link interface 340 (FIG. 3) (e.g., an MHL link interface), the transmitter device 305 and the receiver device 310 may be placed in a deep sleep state by the power save module 410 (or other power save module in the transmitter device 305 and/or the receiver device 310) in which all the AV physical channels (lanes) and also the eCBUS are placed in a standby or shutdown state. In one embodiment, only the Bootstrap CBUS (bCBUS) remains awake and waits for the sleep time out or interruptions triggered externally (e.g., a user command).

In one embodiment, before the transmitter device 305 (FIG. 3) and the receiver device 310 go into the deep sleep state, both the transmitter device 305 and the receiver device 310 record all of the configuration status of the AV channels and eCBUS into the capability registers 323 and 334, respectively. In one embodiment, when the transmitter device 305 and the receiver device 310 need to wake up from the deep-sleep state, both resume the configurations of the AV channels (lanes) and eCBUS immediately without going through a regular initiation process based on reading/retrieving the status information from the respective capability registers 323 and 334.

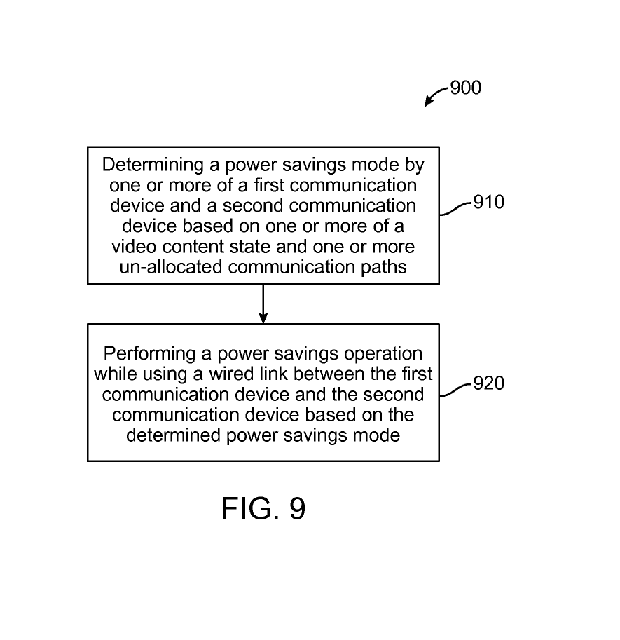

FIG. 9 shows a process 900 for providing power saving for wire connected electronic devices, according to one embodiment. In one embodiment, in block 910 a power saving mode is determined by one or more of a first communication device (e.g., transmitter 305, FIG. 3) and a second communication device (e.g., the receiver 310) based on one or more of a video content state and one or more un-allocated communication paths (e.g., physical channels, logical channels, sub-channels, etc.). In one embodiment, in block 920, a power saving operation is performed while using a wired link (e.g., an MHL wired link, an HDMI wired link, etc.) between the first communication device and the second communication device based on the determined power saving mode.

In one embodiment, process 900 may provide that when the video content state is based on one or more of: content comprising blank video values and no content for transmission. In one embodiment, the process 900 may include that when the content state is based on content comprising blank video values, process 900 may skip packetization of the blank video values during active video periods, add gap values automatically based on the blank video values, and regenerate the blank video values in the active video periods by the receiver device.

In one embodiment, process 900 may provide that the content state is based on the content for blank video values during one or more of a content mute mode and an audio only mode. In one embodiment, when the content state is based on no content available for transmission, process 900 may include communicating a packet comprising an idle control indication, and entering an idle state by one or more of the transmitter device and the receiver device.

In one embodiment, for process 900, the idle control indication may include a time limit indication that the transmitter device and the receiver device remain in the idle state. In one embodiment, process 900 may include that the transmitter skips sending idle characters during the content state that is based on no content available for transmission.

In one embodiment, when the one or more un-allocated communication paths comprises un-allocated sub-channels, process 900 may include maintaining the transmitter device and the receiver device in a standby state based on register information (e.g., eCBUS TDM count and total number of eCBUS channels).

In one embodiment, when the one or more un-allocated communication paths comprises un-allocated physical channels, process 900 may include placing one or more un-allocated physical channels in one of a standby state and a shutdown state by one or more of the transmitter device and the receiver device based on determining particular physical channels that are un-allocated by using register information (e.g., number of allocated AV Lanes and total number of AV physical channels).

In one embodiment, when the content state is based on no content available for transmission, process 900 may include storing configuration status for one or more audio-video channels and one or more link busses e.g., in capability registers 323, 334, FIG. 3), and entering a sleep state by one or more of the transmitter device and the receiver device. In one embodiment, when one or more of the transmitter device and the receiver device are required to awake from the sleep state, process 900 may include one or more of the transmitter device and the receiver device resuming previous configurations based on the stored configuration status without performing an initiation process.

In one embodiment, the transmitter device may be a mobile electronic device (e.g., electronic device 120, FIG. 2), and the receiver device may be an electronic device, such as electronic device 140.

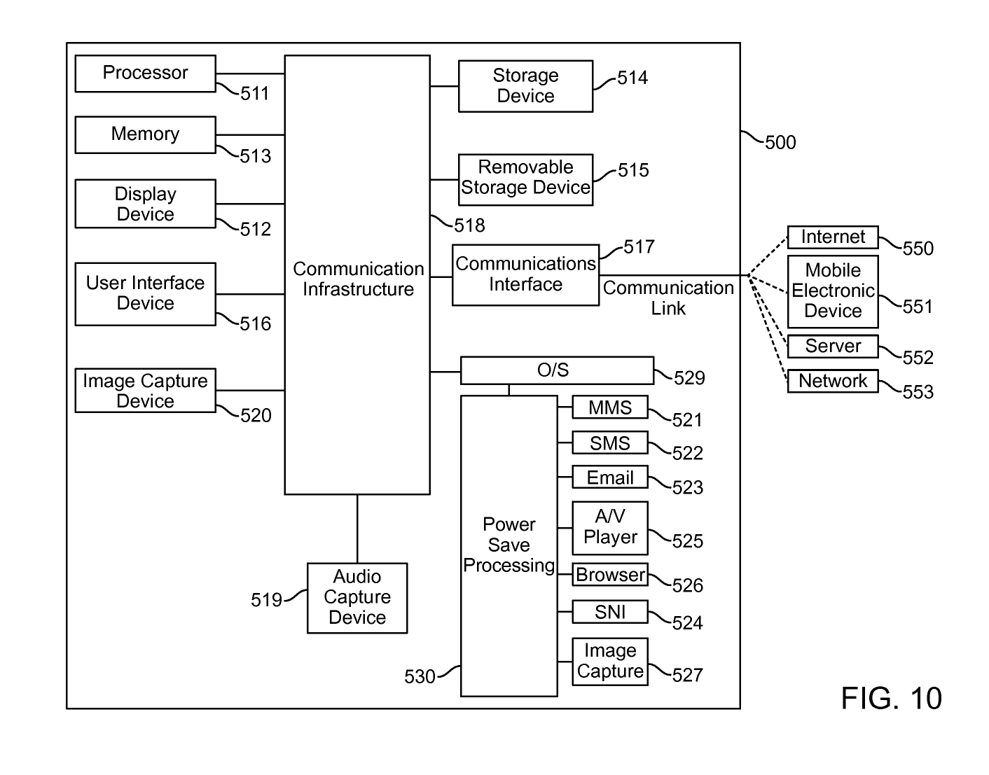

FIG. 10 is a high-level block diagram showing an information processing system comprising a computing system 500 implementing one or more embodiments. The system 500 includes one or more processors 511 (e.g., ASIC, CPU, etc.), and may further include an electronic display device 512 (for displaying graphics, text, and other data), a main memory 513 (e.g., random access memory (RAM), cache devices, etc.), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card).

The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, smartphone, tablet, mobile computing device, wearable device, etc.), the system 500 further includes an image capture device 520, such as a camera 128 (FIG. 2), and an audio capture device 519, such as a microphone 122 (FIG. 2). The system 500 may further include application modules as MMS module 521, SMS module 522, email module 523, social network interface (SNI) module 524, audio/video (AV) player 525, web browser 526, image capture module 527, etc.

In one embodiment, the system 500 includes power saving processing module 530 that may implement power saving features of system 300 and processing similar as described regarding (FIG. 3), and processing as described with reference to the transmitter pipeline 400 (FIG. 4). In one embodiment, the power saving processing module 530 may implement the flow diagram 900 (FIG. 9). In one embodiment, the power saving processing module 530 along with an operating system 529 may be implemented as executable code residing in a memory of the system 500. In another embodiment, the power saving processing module 530 may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method comprising:
determining a power saving mode by one or more of a first communication device and a second communication device based on one or more of a video content state and one or more un-allocated communication paths; and
performing a power saving operation while using a wired link between the first communication device and the second communication device based on the determined power saving mode.

2. The method of claim 1, wherein:
the video content state is based on one or more of: content comprising blank video values and no content for transmission; and
the one or more un-allocated communication paths comprise one or more of un-allocated sub-channels and un-allocated physical channels.

3. The method of claim 2, wherein the wire connection comprises one or more of a mobile high-definition link (MHL) connection and a high-definition multimedia interface (HDMI) connection, and the first communication device and the second communication device each comprise one of a transmitter device and a receiver device.

4. The method of claim 3, wherein when the content state is based on content comprising blank video values, the method further comprising:
skipping packetization of the blank video values during active video periods;
adding gap values automatically based on the blank video values; and
regenerating the blank video values in the active video periods by the receiver device.

5. The method of claim 4, wherein the content state is based on the content comprising blank video values during one or more of a content mute mode and an audio only mode.

6. The method of claim 3, wherein when the content state is based on no content available for transmission, the method further comprising:
communicating a packet comprising an idle control indication; and
entering an idle state by one or more of the transmitter device and the receiver device.

7. The method of claim 6, wherein the idle control indication includes a time limit indication that the transmitter device and the receiver device remain in the idle state.

8. The method of claim 7, wherein the transmitter skips sending idle characters during the content state that is based on no content available for transmission.

9. The method of claim 3, wherein when the one or more un-allocated communication paths comprise un-allocated sub-channels, the method further comprises:
maintaining the transmitter device and the receiver device in a standby state based on register information.

10. The method of claim 3, wherein when the one or more un-allocated communication paths comprise un-allocated physical channels, the method further comprising:
placing one or more un-allocated physical channels in one of a standby state and a shutdown state by one or more of the transmitter device and the receiver device based on determining particular physical channels that are un-allocated by using register information.

11. The method of claim 3, wherein when the content state is based on no content available for transmission, the method further comprising:
storing configuration status for one or more audio-video channels and one or more link busses; and
entering a sleep state by one or more of the transmitter device and the receiver device.

12. The method of claim 11, wherein when one or more of the transmitter device and the receiver device are required to awake from the sleep state, one or more of the transmitter device and the receiver device resume previous configurations based on the stored configuration status without performing an initiation process.

13. The method of claim 3, wherein the transmitter device comprises a mobile electronic device, and the receiver device comprises one of: a television device and a display device.

14. A system comprising:
a wire connection device;
a first communication device coupled to a first connector of the wire connection device; and
a second communication device coupled to a second connector of the wire connection device, wherein one or more of the first communication device and the second communication device determines a power saving mode based on one or more of a video content state and one or more un-allocated communication paths for the wire connector, and performs a power saving operation based on the determined power saving mode.

15. The system of claim 14, wherein:
the video content state is based on one or more of: content comprising blank video values and no content for transmission; and
the one or more un-allocated communication paths comprise one or more of un-allocated sub-channels and un-allocated physical channels.

16. The system of claim 15, wherein the wire connection device comprises one or more of a mobile high-definition link (MHL) connection device and a high-definition multimedia interface (HDMI) connection device, and the first communication device and the second communication device comprise one of a transmitter device and a receiver device.

17. The system of claim 16, wherein when the content state is based on content comprising blank video values:
the transmitter device skips packetization of the blank video values during active video periods, and adds gap values automatically based on the blank video values; and
the receiver device regenerates the blank video values in the active video periods.

18. The system of claim 17, wherein the content state is based on the content comprising blank video values during one or more of a content mute mode and an audio only mode.

19. The system of claim 16, wherein when the content state is based on no content available for transmission:
the transmitter device communicates a packet comprising an idle control indication with the receiver device, and one or more of the transmitter device and the receiver device enter an idle state.

20. The system of claim 19, wherein the idle control indication includes a time limit indication that the transmitter device and the receiver device remain in the idle state.

21. The system of claim 20, wherein the transmitter skips sending idle characters during the content state that is based on no content available for transmission.

22. The system of claim 16, wherein when the one or more un-allocated communication paths comprises un-allocated sub-channels:
the transmitter device and the receiver device remain in a standby state based on register information.

23. The system of claim 16, wherein when the one or more un-allocated communication paths comprises un-allocated physical channels:
one or more of the transmitter device and the receiver device place one or more un-allocated physical channels in one of a standby state and a shutdown state based on determining particular physical channels that are un-allocated by using register information.

24. The system of claim 16, wherein when the content state is based on no content available for transmission:
one or more of the transmitter device and the receiver device stores configuration status for one or more audio-video channels and one or more link busses and enter a sleep state.

25. The system of claim 24, wherein when one or more of the transmitter device and the receiver device are required to awake from the sleep state, one or more of the transmitter device and the receiver device resume previous configurations based on the stored configuration status without performing an initiation process.

26. The system of claim 16, wherein the transmitter device comprises a mobile electronic device, and the receiver device comprises one of: a television device and a display device.

27. A non-transitory computer-readable medium having instructions which when executed on a computer performing a method comprising:
determining a power saving mode by one or more of a first communication device and a second communication device based on one or more of a video content state and one or more un-allocated communication paths; and
performing a power saving operation while using a wired link between the first communication device and the second communication device based on the determined power saving mode.

28. The medium of claim 27, wherein:
the video content state is based on one or more of: content comprising blank video values and no content for transmission; and
the one or more un-allocated communication paths comprise one or more of un-allocated sub-channels and un-allocated physical channels.

29. The medium of claim 28, wherein the wire connection comprises one or more of a mobile high-definition link (MHL) connection and a high-definition multimedia interface (HDMI) connection, and the first communication device and the second communication device each comprise one of a transmitter device and a receiver device.

30. The medium of claim 29, wherein:
when the content state is based on content comprising blank video values, the method further comprising:
skipping packetization of the blank video values during active video periods;
adding gap values automatically based on the blank video values; and
regenerating the blank video values in the active video periods by the receiver device;
when the content state is based on no content available for transmission, the method further comprising:
communicating a packet comprising an idle control indication; and
entering an idle state by one or more of the transmitter device and the receiver device;
when the one or more un-allocated communication paths comprise un-allocated sub-channels, the method further comprises:
maintaining the transmitter device and the receiver device in a standby state based on register information; and
when the one or more un-allocated communication paths comprises un-allocated physical channels, the method further comprising:
placing one or more un-allocated physical channels in one of a standby state and a shutdown state by one or more of the transmitter device and the receiver device based on determining particular physical channels that are un-allocated by using register information.

31. The medium of claim 30, wherein:
the content state is based on the content comprising blank video values during one or more of a content mute mode and an audio only mode;
the idle control indication includes a time limit indication that the transmitter device and the receiver device remain in the idle state; and
the transmitter skips sending idle characters during the content state that is based on no content available for transmission.

32. The medium of claim 29, wherein when the content state is based on no content available for transmission, the method further comprising:
storing configuration status for one or more audio-video channels and one or more link busses; and
entering a sleep state by one or more of the transmitter device and the receiver device,
wherein when one or more of the transmitter device and the receiver device are required to awake from the sleep state, one or more of the transmitter device and the receiver device resume previous configurations based on the stored configuration status without performing an initiation process.

33. The medium of claim 29, wherein the transmitter device comprises a mobile electronic device, and the receiver device comprises one of: a television device and a display device.
